(19) United States
(12) Patent Application Publication
(10) Pub. No.: US 2006/0292533 A1
(43) Pub. Date: Dec. 28, 2006

(54) System and method for gait training

(76) Inventor: Omar F. Selod, Fort Worth, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 11/158,606

(22) Filed: Jun. 22, 2005

(51) Int. Cl. A63B 69/00; G09B 19/00; G09B 9/00

(52) U.S. Cl. 434/247

(57) ABSTRACT

A gait training system comprising an ambulation assistance device operable to provide support for an ambulating user and a target projection device attached to said ambulation assistance device, the target projection device operable to project a guide target on a predetermined position on a surface, the guide target positioned so a user can step on the guide target while ambulating in a predetermined gait.

### TECHNICAL FIELD

The invention relates to gait training and more particularly to systems and methods comprising ambulation assist devices for gait training.

### BACKGROUND OF THE INVENTION

Gait disorders affecting ambulation are extremely common. Whether due to illness, age, or extremity damage, a loss of ambulation can be devastating for a patient. Typical methods for treating gait disorders may comprise the use of pharmaceuticals and/or surgery. While some gait disorders can be completely resolved by pharmaceuticals, pharmaceutical therapy is not an option in many cases. Surgical procedures can be used to resolve yet other ambulation disorders. However, recovery from surgical procedures often results in an initial rehabilitation period during which ambulation either fails to improve or worsens as a patient heals.

Physical therapy is known to those of ordinary skill in the art to be an effective method for treating gait disorders. Often, patients are given instructions to practice various types of physical therapy that involve ambulation using various gaits. When a physical therapist or other health professional is available to observe the patient's performance of the physical therapy, patient mistakes and bad habits can be averted. Because the time of health professionals is valuable, constant supervision of a patient is not always practical, particularly when a patient is at home or outside a hospital setting. However, when a patient practices a prescribed physical therapy without supervision, bad habits and mistakes can result if the prescribed physical therapy is performed incorrectly.

### BRIEF SUMMARY OF THE INVENTION

The present invention is directed to systems and methods which provide gait training. In certain embodiments of the invention, a target projection device projects a guide target onto a surface suitable for ambulation. A user employs the projected guide target as an indication of a location on the surface to place a foot, body part, or prosthetic device. The target projection device comprises c-clips or other attachment devices such as straps or adhesive strips operable to attach the target projection device to an ambulation assist device. Use of the guide target can prevent a user from developing bad habits or making mistakes during, for example, physical therapy, or simply moving with poor or undesirable gait. Also, certain embodiments of the invention can be used without medical supervision, reducing the costs of gait therapy. Furthermore, certain embodiments are usable in a non-hospital setting such as a user's home or workplace, which is convenient for a user. A desired gait or gaits can be maintained, or a present gait can be enhanced using certain embodiments of the invention in a non-hospital and/or non-therapy application.

A gait training system according to an embodiment of the invention can comprise an ambulation assist device to which is attached a target projection device. The target projection device projects a plurality of guide targets onto a surface suitable for ambulation. A user steps onto the guide targets as gait training, which may be part of a more comprehensive physical therapy program, prescribed treatment, or at a user's initiative. The target projection device comprises adjustable light sources that are initially or continually adjustable by a health care provider and/or a user. In a preferred embodiment, the ambulation assist device is a walker.

In certain embodiments, a projected guide target from a target projection device is accompanied by aural and tactile stimuli delivered, for example, by a speaker and a vibrating hand grip. The guide target and accompanying stimuli can be activated or deactivated when the target projection device detects a predetermined condition, such as no detection of movement for a predetermined period of time. Target projection device may be manually operable in certain embodiments through the use of an attached or remote switch.

A target projection device can be used in certain embodiments to project a guide target using laser light. For use with, for example, pediatric patients, the guide target can be of a pleasing and/or stimulating shape such as a cartoon character. Another feature of certain embodiments is a light detection sensor that detects reflected laser light. A user can be equipped with footwear comprising reflective portions in certain embodiments of the invention, so that laser light is only reflected when a user is standing on or obscuring the guide target. When the target projection device detects reflected light, the guide target can be switched off, and/or aural and/or tactile stimuli can be generated.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly-understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is an illustration of a gait training system comprising an ambulation assist device and an attached target projection device according to an embodiment of the present invention;

FIG. 2 is a block diagram of an embodiment of the present invention;

FIG. 3 is an illustration of a target projection device according to an embodiment of the present invention;

FIG. 4A is an illustration of an ambulation assist device and an attached target projection device comprising a single adjustable light source according to an embodiment of the invention;

FIG. 4B is an illustration of an ambulation assist device with an attached target projection device according to an embodiment of the present invention; and

FIG. 5 is a wheelchair and attached target projection device according to an embodiment of the present invention.

### DETAILED DESCRIPTION OF THE INVENTION

Unless defined otherwise, technical and scientific terms used herein have the same meaning as commonly understood by one of ordinary skill in the art to which this invention belongs.

As used herein, the use of the word “a” or “an” when used in conjunction with the term “comprising” in the claims and/or the specification may mean “one,” but is it also consistent with the meaning of “one or more,” “at least one,” and “one or more than one.” Still further, the terms “having”, “including”, “containing” and “comprising” are interchangeable and one of skill in the art is cognizant that these terms are open-ended terms.

Certain embodiments of the present invention comprise a target projection device that provides a guide target for an ambulating user. The guide target is projected to a predetermined position and the ambulating user is instructed to try to step on or obscure the guide target. The predetermined position can be adjusted as appropriate according to gait training goals for the ambulating user. Gait training goals may comprise, for example, curing or alleviating gait disorder symptoms, restoring normal gait, enhancing constitution, etc. Changes and/or improvement to a user's length of stride, stance, and other gait characteristics are examples of gait training goals achievable using certain embodiments of the present invention.

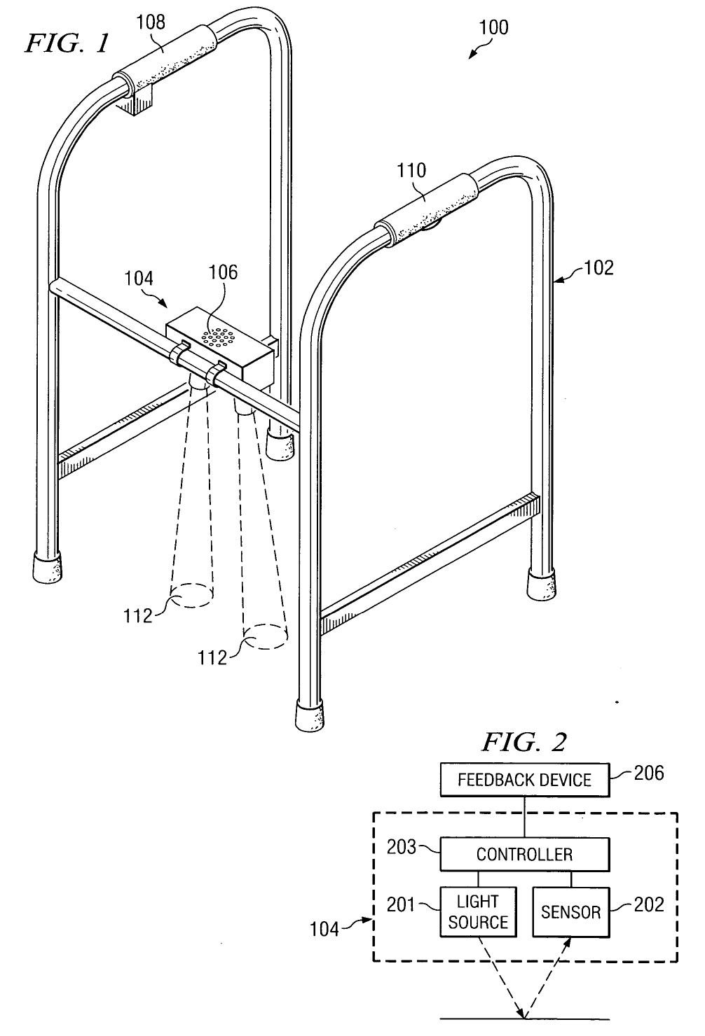

With reference to the drawing, FIG. 1 shows a gait training system according to an embodiment of the present invention. Gait training system 100 is usable for stand-alone gait training for a variety of medical disorders and physical states affecting a user's ability to ambulate. Gait training system 100 may also be used together with other gait disorder therapies, such as pharmaceutical and surgical treatments. Gait training system 100 can be operated by a user to maintain or enhance a present gait.

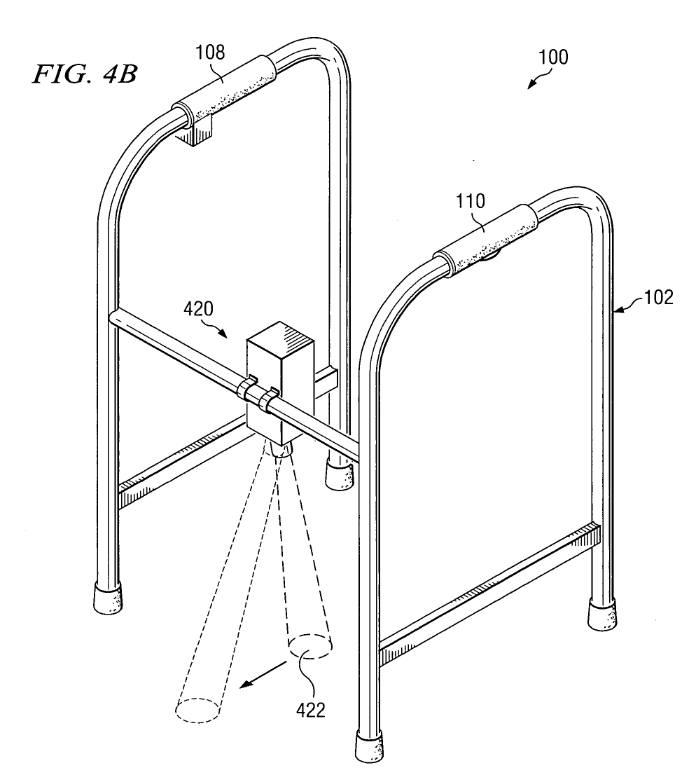

Gait training system 100 comprises ambulation assist device 102. Ambulation assist device 102 takes the form of any of a number of such devices known to those of skill in the art. For example, ambulation assist devices usable as components of Gait training system 100 are walkers, wheelchairs, etc. Such ambulation assist devices provide support, guidance, and/or stabilization for a user. In FIG. 1, ambulation assist device 102 is a walker. Other walker designs are usable with the present invention, such as the walker design shown in FIG. 4A, or, for example, wheeled walkers. 1 Gait training system 100 further comprises target projection device 104 attached to ambulation assist device 102. Target projection device 104 may be attached to ambulation assist device 102 using a variety of methods. Attachment components such as straps, clips, and harnesses are used with certain embodiments of the present invention. Target projection device 104 is attached as an integral component of ambulation assist device 102 in other embodiments. For example, target projection device 104 can be welded to ambulation assist device 102. Target projection device 104 can be attached at a variety of attachment points on ambulation assist device 102, and on alternative ambulation assist devices. Embodiments of the invention are not limited to the methods of attachment disclosed above, and other methods of attachment known to those of skill in the art may be used.

Target projection device 104 may comprise a light source in embodiments of the present invention. Various light sources can be used, such as incandescent light, fluorescent light, light emitting diodes (LEDs), plasma sources, ultraviolet sources, etc. In preferred embodiments of the present invention, a laser light source is used. In certain embodiments of the present invention, a pleasing guide target 112 can be projected by light source. For example, an embodiment for training pediatric patients projects cartoon figures or animal shapes for the pediatric user to step on. Other guide targets are of varying shapes, sizes, and colors. Guide target 112 can also flash, change colors, or provide other interesting visual stimuli. More than one light source can be used to project a plurality of guide targets. In a preferred embodiment, target projection device 104 comprises two light sources which each project a guide target. In these embodiments, a guide target 112 can be adjusted for each foot of a user. Certain embodiments allow users to select the number of light sources used and/or number of guide targets projected. A switch can be used to select between, for example, two guide targets, a left guide target, or a right guide target. A switch can also be used to lock the target projection device 104 in place or the guide target 112. The switch can be located on the ambulation assist device 102 or on the target projection device 104.

Certain embodiments of the present invention comprise a target projection device 104 that projects guide target 112 using sound waves or radiofrequency. These embodiments are ideal for use with, for example, visually-impaired patients.

Aural or tactile stimuli may be provided to accompany a projected guide target. An aural or tactile indicator can be provided to emit sound when, for example, a user steps on the guide target projected by the target projection device. Aural stimuli and indicators can be issued by speaker 106 or similar device known to those of ordinary skill in the art. Similarly, tactile stimulation may be provided via, for example, vibrating handgrip 108 or other device known to those of ordinary skill in the art. Communication between target projection device 104 and speaker 106 and/or vibrating handgrip 108 can be maintained using wired or wireless means known to those of ordinary skill in the art. In certain embodiments, second handgrip 110 is equipped with a pressure-sensitive switch on the underside that is operable to turn target projection device 104 on or off. Target projection device 104 may also be turned on or off using a switch mounted on the device itself in certain embodiments.

As the ambulation assist device 102 is lifted by a user using the handgrips, the pressure-sensitive switch on the underside of second handgrip 110 turns off the guide target 112 projected by target projection device 104. The guide target projection can be turned off to save power and/or prevent user confusion if many devices are being employed in the same locale, such as a hospital.

FIG. 2 shows a block diagram of an embodiment of the present invention. In this embodiment, target projection device 104 is comprised of light source 201, sensor 202, and controller 203. Light source 201 emits light energy to generate a guide target. Light energy is reflected by reflective object 205 placed in the path. Reflected light is detected by sensor 202, which provides information to controller 203, which in turn activates feedback device 206.

In certain embodiments, reflective object 205 is footwear with a reflective portion being worn by a user. Target projection device 104 is operable to turn off projected guide target from light source 201 when reflected light is detected by sensor 202 for detecting the reflected light. For example, when a user wearing footwear with reflective object 205 steps into light from a projected guide target, light reflects to sensor 202 and target projection device turns off a projected guide target from light source 201. Alternatively or in addition, target projection device turns on a different guide target when light from a second guide target is detected.

Additionally or alternately, when reflected light is detected by sensor 202, aural and/or tactile stimuli can be generated by feedback device 206. Feedback device 206 may be a speaker or vibrating handgrip in certain embodiments. In certain embodiments, target projection device 104 projects a guide target with radiofrequency (RF) or sound energy. Reflected RF and sound energy can be detected by appropriate detectors, such as photo sensors or microphones connected to the target projection device.

In certain embodiments, reflective object 205 may comprise material that glows when placed in the light from light source 201. A user receives feedback by noting that reflective object 205 glows when footwear with reflective objection 205 is placed in the light from light source 201. An ultraviolet light source can be used and reflective object 205 can be comprised of material that radiates visible light in response to an ultraviolet light source. Footwear worn by a user can also have a sensor that detects the presence of light from light source 201 and provides a stimulus to a user when such light is detected.

Certain embodiments of the present invention comprise a motion sensor connected to target projection device 104 that activates the target projection device depending on the movements or lack of movements a user has made.

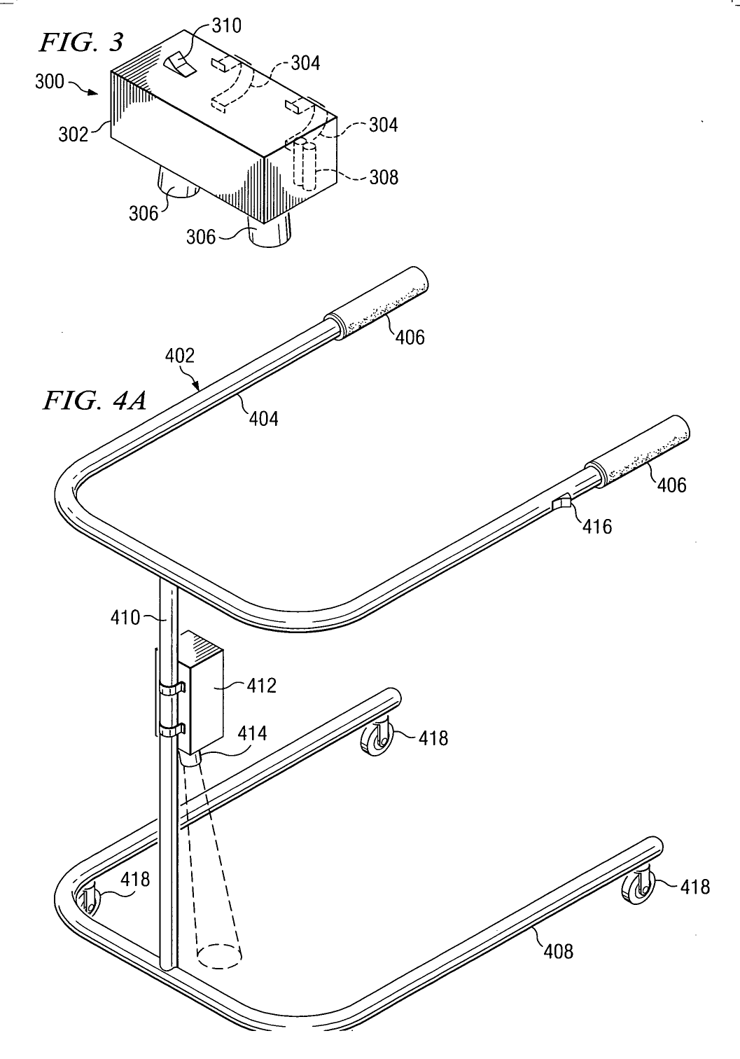

FIG. 3 is an illustration of a target projection device according to an embodiment of the present invention. Target projection device 104 comprises body 302. In preferred embodiments of the present invention, target projection device body 302 is comprised of lightweight materials. Plastics, light metals such as aluminum, and composite materials are used in these embodiments. However, other materials can be used in other embodiments of the present invention. In this embodiment, two plastic or metal c-clips 304 are mounted on body 302. More or fewer c-clips can be used in other embodiments, and other mounting devices are also usable with embodiments of the invention.

Target projection device 104 further comprises adjustable light sources 306. In this embodiment, two adjustable light sources are present, but more or fewer light sources may be present in other embodiments. Adjustable light sources 306 are movable to adjust the position of a projected guide target. As noted above, certain embodiments of the present invention project sound or radiofrequency energy that can be used to generate guide targets. Adjustments to adjustable light sources 306 can be made at any time in certain embodiments.

In a preferred embodiment, adjustments are made initially to adjustable light sources 306 by having a user stand in a desired stance that achieves gait training goals. Such a stance comprises a user holding an ambulation assistance device in a correct position. When the user is in the desired stance and the ambulation assistance device is positioned correctly, adjustable light sources 306 are adjusted to project a guide target on each of user's feet. The position of the adjustable light sources is then locked into place. Thereafter, when the user moves the ambulation assistance device, target projection device 104 projects guide targets in a location that correctly positions a user relative to the ambulation assistance device and/or identifies a correct stance for the user.

Certain embodiments of the present invention comprise adjustable light sources 306 that are automatically adjustable using, for example, motors. As a user is operating an ambulation assist device to which target projection device 104 is connected, adjustable light sources can be programmed to move projected guide targets to achieve gait training goals. FIG. 4B shows such an adjustable light source.

Returning to FIG. 3, target projection device 104 comprises battery power source 308 in preferred embodiments of the present invention. Batteries used in battery power source 308 can be single use batteries, rechargeable batteries, miniature batteries, etc. In certain embodiments, a solar power source is included to recharge the battery power source and/or provide power for target projection device 104. Similarly, a motion-powered electric generator can be used in other embodiments to generate electric power when target projection device 104 is moved by a user.

On/off operation of target projection device 104 is controlled by switch 310 in preferred embodiments. Switch 310 is located on target projection device 104. In other embodiments, switch 310 can be connected remotely to target projection device 104 by means known to those of ordinary skill in the art, such as a direct electrical connection, a mechanical linkage, an RF transmitter/receiver, etc. Other switches, such as push button or rocker switches, can be used in yet other embodiments. A switch, such as a pressure switch, can be located on a portion of an ambulation assistance device in contact with the ground. For example, a pressure switch can be located on the bottom of a walker's “feet”.

Referring now to system 400 illustrated in FIG. 4, ambulation assist device 402 comprises u-shaped handle 404 with handgrips 406 at either end. In this embodiment, second u-shaped component 408 is connected to u-shaped handle 404 via a vertical connector 410. Target projection device 412 is attached to vertical connector 410 via c-clips. In other embodiments, different methods may be used to attach target projection device 412 to vertical connector 410. In this embodiment, target projection device 412 comprises a single adjustable light source 414. In other embodiments of the present invention, additional target projection devices may be present. System 400 also comprises switch 416 operable to control target projection device 412. Switch 416 controls target projection device 412 remotely using RF signals in this embodiment. A direct wire connection can be used, as can remote signals using sound energy. Also in this embodiment, ambulation assist device 402 comprises four wheels 418.

Adjustable light source 414 can be positioned at any time, or may be set and locked into place. In a preferred embodiment, initial adjustment of adjustable light source 414 occurs when a user stands within ambulation assist device 402 in a desired position and adjusts adjustable light source 414 to project a guide target on one foot. Thereafter, as the ambulation assist device 402 is moved, the projected guide target indicates the position a user should step on. In other embodiments with a plurality of adjustable light sources 414, each light source can be adjusted independently or as a group. Other adjustment methods may be used, and adjustment can be made to best effect desired gait therapy goals.

FIG. 4B shows system 100 comprising an ambulation assist device 102 with handgrips 108 and 110. In this embodiment, target projection device 420 projects a single guide target 422. The light source of target projection device 420 is automatically adjustable and moves forward automatically when, for example, reflected light is detected after a user steps on guide target 422. Automatic adjustment may also occur after a certain period of time, or, for example, when a user manually moves a switch or other control means on handles 108, 110.

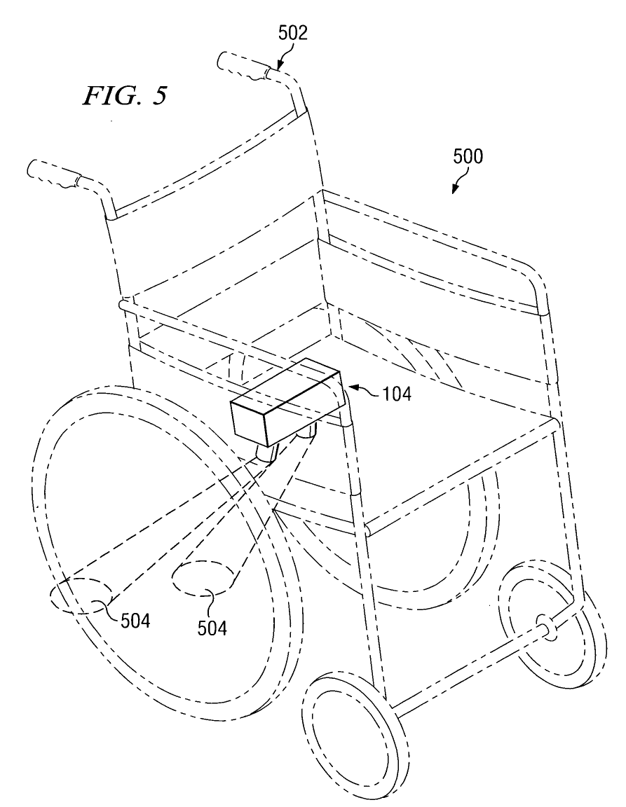

FIG. 5 is an illustration of an embodiment of the present invention comprising a wheelchair system 500. In this embodiment, target projection device 104 is attached to the underside of wheelchair 502 using attachment methods described above. In other embodiments, alternate attachment points are used such as, for example, the top and backside. Target projection device 104 projects guide targets 504 behind wheelchair 502 to provide gait therapy for a user pushing wheelchair 502. In other embodiments, guide targets may be projected in front of the wheelchair 502 to indicate where a user sitting in wheelchair 502 should place his or her feet in order to stand.

Embodiments of the present invention may be used to treat a variety of gait disorders. Generally, gait disorders such as impaired ambulation or uncertainty with ambulation are particularly suitable for gait training by embodiments of the present invention. Gait disorders treated by embodiments of the present invention may result from a variety of patient ailments. Listed below are patient ailments that cause or comprise gait disorders in some affected individuals. Embodiments of the invention can also be used by users that are not afflicted with an ailment, but desire to enhance or maintain a gait via gait training.

Stroke patients may have a variety of gait disorders that occur as a result of central nervous tissue destruction. Strokes resulting from embolism-induced ischemia and vessel hemorrhage leave many patients with gait disorders from paralysis or partial paralysis. Additional gait disorders resulting from stroke may result from stroke-induced hemiparesis, hemiplegia, apraxia, ataxia, spasticity, and weakness. Traumatic brain and spinal cord injury and other brain injuries can also result in gait disorders treatable by embodiments of the present invention.

Deconditioning occurs as a result of many medical conditions such as heart failure and pulmonary disorders that prevent a patient from maintaining normal activity levels. Deconditioning also occurs in patients that are overweight, elderly, recovering from periods of bed rest, lack of exercise, etc. Deconditioned patients often suffer from gait disorders. Certain embodiments of the present invention are suitable for treatment of gait disorders resulting from deconditioning.

Surgical procedures can often result in temporary or permanent gait disorders. Temporary gait disorders resulting from orthopedic surgical procedures are particularly suited for treatment by embodiments of the present invention. Procedures such as hip or knee replacement, surgical correction of deformity or fracture, and surgical arthritis treatment are examples of surgical procedures that result in temporary gait disorder treatable using embodiments of the present invention. In certain cases, embodiments of the invention can be prescribed as part of a post-operative physical therapy regimen for many surgical procedures.

Pediatric patients with gait disorders may be treated using embodiments of the present invention. Cerebral palsy, Down's Syndrome, brain injury, developmental delay, polio and pediatric orthopedic problems can result in pediatric gait disorders treatable using embodiments of the present invention described herein.

Various peripheral neuropathies can cause gait disorders. Peripheral neuropathy caused by, for example, diabetes, thyroid dysfunction, and circulatory problems can produce ambulation disorders treatable by certain embodiments of the present invention.

Ambulation after amputation or limb injury can be restored through the use of prosthetic limbs or body parts. Use of prosthetics can result in temporary gait disorders until a patient learns how to use the prosthetic. Embodiments of the present invention can be used to treat gait disorders resulting from patients being equipped with prosthetic body parts.

Certain visual disturbances and disorders of the vestibular system can result in ambulation disorders treatable using embodiments of the present invention. Various pharmaceuticals can also cause ambulation disorders. Degenerative and demyelinating diseases such as multiple sclerosis also result in ambulation disorders for affected

Gait disorders can result from ingestion and deficiencies of various compounds. For example, ingestion of alcohol and organomercury compounds cause gait disorders, as can vitamin B12 deficiency.

The specific disorders discussed above are exemplary in nature and are not intended to be exclusive. While embodiments of the present invention may be used to treat gait disorders arising from any of the above illnesses, embodiments may provide gait training for many other illnesses and gait disorders not described above.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A gait training system comprising:
an ambulation assistance device operable to provide support for an ambulating user; and
a target projection device attached to said ambulation assistance device, said target projection device operable to project a guide target on a predetermined position on a surface, said guide target positioned so a user can step on said guide target while ambulating in a predetermined gait.

2. The gait training system of claim 1 wherein said target projection device is adjustable to move said target.

3. The gait training system of claim 2 wherein said target projection device is adjusted automatically.

4. The gait training system of claim 1 comprising a plurality of target projection devices.

5. The gait training system of claim 1 wherein said target projection device is operable to project a plurality of guide targets.

6. The gait training system of claim 1 wherein said ambulation assistance device comprises:
a control switch connected to said target projection device, said control switch operable to turn the device on and off automatically.

7. The gait training system of claim 1 wherein said target projection device comprises an energy source for projecting said guide target selected from the group consisting of:
laser energy source, sound energy source, radiofrequency energy source, and visible light energy source.

8. The gait training system of claim 1 further comprising:
a motion sensor and a timer, and wherein said target projection device is activated when said motion sensor detects no motion within a predetermined time period measured by said timer.

9. The gait training system of claim 1 further comprising:
a speaker for providing aural stimuli, said speaker connected to said target projection device, said speaker activated when a user steps on said guide target.

10. The gait training system of claim 1 further comprising:
a vibrating device for providing tactile stimuli, said vibrating device connected to said target projection device, said vibrating device activated when a user steps on said guide target.

11. A method for gait training comprising:
providing an ambulation assistance device operable to provide support for an ambulating user;
providing a target projection device attached to said ambulation assistance device, adjusting said target projecting device to project a guide target on a surface suitable for ambulation, at a position on said surface selected to have a user step on; and
projecting said guide target.

12. The method of claim 11 further comprising:
adjusting said guide target based on user ambulation characteristics.

13. The method of claim 11 wherein said projecting comprises:
projecting said guide target when said ambulation assistance device has not moved for a predetermined amount of time.

14. The method of claim 11 wherein said target projection device comprises an energy source selected from the group consisting of:
laser energy source, sound energy source, radiofrequency energy source, and visible light energy source.

15. The method of claim 1 1 further comprising:
detecting whether said guide target has been stepped on; and
providing a stimuli when said guide target has been stepped on.

16. The method of claim 11 further comprising:
adjusting said guide target according to treatment goals for a user.

17. An apparatus for gait training comprising:
means for projecting a guide target at a predetermined location, said guide target location coincident with a desired location for a user to step on, said desired location predetermined to assist with therapy of a gait disorder; and
means for attaching said means for projecting to an ambulation assistance device.

18. The apparatus of claim 17 further comprising:
means for detecting energy from said guide target projected from said means for projecting, said means connected to said means for projecting.

19. The apparatus of claim 17 wherein said means for projecting further comprises:
means for projecting said guide target when said ambulation assistance device has not moved for a predetermined amount of time.

20. The apparatus of claim 17 further comprising:
means for providing user stimuli, said means connected to said ambulation assist device, said user stimuli selected from the group consisting of:
aural stimuli, tactile stimuli, and combinations thereof.
